(19) United States
(12) Patent Application Publication
(10) Pub. No.: US 2016/0257097 A1
(43) Pub. Date: Sep. 8, 2016

(54) WINGED FIBER MAT

(71) Applicant: Cintas Corporation, Cincinnati, OH (US)

(72) Inventors: Richard R. Bing, West Chester, OH (US); Patrick J. Chilenski, Cincinnati, OH (US); David Mesko, Wyoming, OH (US)

(73) Assignee: Cintas Corporation, Cincinnati, OH (US)

(21) Appl. No.: 15/058,214

(22) Filed: Mar. 2, 2016

Related U.S. Application Data
(60) Provisional application No. 62/127,409, filed on Mar. 3, 2015.

(51) Int. Cl. B32B 27/06; B32B 5/02

(52) U.S. Cl. CPC B32B 27/06; B32B 5/022; B32B 5/024; B32B 2471/04; B32B 2307/726; B32B 2262/0276; B32B 2262/0253

(57) ABSTRACT

A floor mat includes a combination of a winged fiber pile and a liquid impervious base. The mat may be used in many consumer and industrial environments where protection from inclement weather is desired as well as in industrial clean rooms, laboratories and hospitals. The winged fibers have a high surface area because of their structure including a core surrounded by a plurality of lobes. Channels of one micron or less in width are formed between adjacent lobes to form paths for the capture and/or transport of gases, liquids or particles. The winged fibers are assembled in woven or non-woven fabrics for use in floor mats.

### CROSS REFERENCE TO RELATED APPLICATION

This claims the benefit of U.S. Provisional Patent Application Ser. No. 62/127,409, filed on Mar. 3, 2015, which is incorporated herein by reference in its entirety.

### BACKGROUND OF THE INVENTION

This invention is directed to mats useful for protecting floor surfaces from being soiled by contact with dirty liquids or other sources of dirt or contamination. Such mats are useful at entryways to buildings to collect soil and liquids and as protection from the elements as well as useful in hallways in office buildings, restaurants, between factories and offices, entrances to laboratories, industrial clean rooms, and the like. Furthermore, such mats will be useful in association with likely spill areas such as locations for vending machines or other beverage dispensers. In particular, this invention is directed to such mats that are highly absorbent and yet can be produced and marketed at a cost consistent with economic realities.

For as long as people have walked on floors, there has been a problem of preventing people from slipping and falling on those floors. The problem is particularly pronounced when the floors are in industrial settings, restaurants, garages and/or public areas. In such areas, water, oil, grease, food, or other liquid or moist materials are frequently deposited or spilled onto the floor surface, presenting a significant hazard to pedestrians and generally unclean conditions. Efforts to keep such surfaces clean and dry are often futile, as the instances and/or quantities of spillage are too great.

In industry in particular, efforts to overcome the above problem have included throwing mats or other temporary surfaces on the permanent base floor. Examples of the former range from carpeting, throw rugs, and other woven or tufted fabric mats while the latter types principally are made of paper-like materials such as are commonly found in new automobiles or runners used in protecting carpeting in newly constructed housing. Such mats themselves may collect water and other liquids and even become at least temporarily saturated with water or oily materials. Saturated mats also need to be cleaned and the industrial cleaning of such mats has been known to damage some mats and shorten their useful lifespan.

Therefore, it would be beneficial to provide a floor mat which is reusable, washable in industrial cleaning systems and able to better absorb liquids such as water, oil, and food, and provide a relatively skid-free surface for pedestrian traffic.

In spite of the wide variety of known mats, many of which are absorbent and useful in various environments, there is a need for a higher performing mat which offers a higher degree of absorbency and fluid retention. Such a mat should likewise be sufficiently durable for use at entryways and the like and can withstand repeated commercial, industrial or other cleaning.

### SUMMARY OF THE INVENTION

This invention is directed to improved articles of manufacture such as floor mats in one embodiment that include woven, knitted, braided or non-woven mat fiber comprised of macro sized fibers having an increased surface area to size ratio. This permits usage of fibers of a more normal cross-sectional size, used in the industry, to have a substantially increased surface area. Particularly, this invention in various embodiments is directed to improved floor mats that have a mat pile of winged fibers. The winged fibers may include a core having multiple lobes extending outwardly from the core to provide a number of channels which may measure 1 micron or less in width. The lobes provide a significant increase in surface area compared to non-winged fibers having the same denier.

In one embodiment, the fibers may be used in a pile portion of a floor mat. A floor mat constructed using the winged fibers can have excellent absorbency, up to 6 times its own weight.

This disclosure relates to floor mats that comprise polymeric winged fibers. The winged fibers have a high surface area because of their structure, which includes a core surrounded by a plurality of lobes. Channels of one micron or less in width are formed between adjacent lobes to form paths for the capture and/or transport of gases, liquids or particles. The winged fibers are assembled in woven or non-woven fabrics for use in floor mats.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of an exemplary floor mat positioned on a floor adjacent to a doorway;

FIG. 2 is a perspective view of another exemplary floor mat with a corner thereof being folded to show a back surface thereof;

FIG. 3 is a perspective view of portions of a number of exemplary floor mats according to various embodiments of this invention;

FIG. 4 is an enlarged view of winged polymeric fibers which may be used in a floor mat according to embodiments of this invention; and

FIGS. 5-6 are schematic cross-sectional views of winged fibers which may be used in floor mats according to embodiments of this invention.

### DETAILED DESCRIPTION OF THE INVENTION

This invention in various embodiments provides an improved floor mat that is highly absorbent and finds applications as protection at building entryways, clean rooms, laboratories, hospitals, restaurants and the like where there is high traffic likely to bring in water, dirt, or other contaminants. The floor mat of this invention is highly absorbent and durable to withstand commercial cleaning yet may be produced economically. These benefits and advantages are attained as a result of the specific structure of the mat which may combine a winged fiber upper wear layer, pile or mat fiber providing a highly absorbent fiber layer which may include cellulose or other fibers in combination with a base that may be liquid impervious. The combination may be tufted or bonded by various means, including for example by a patterned application of sonic energy or heat and pressure as well as vulcanized rubber.

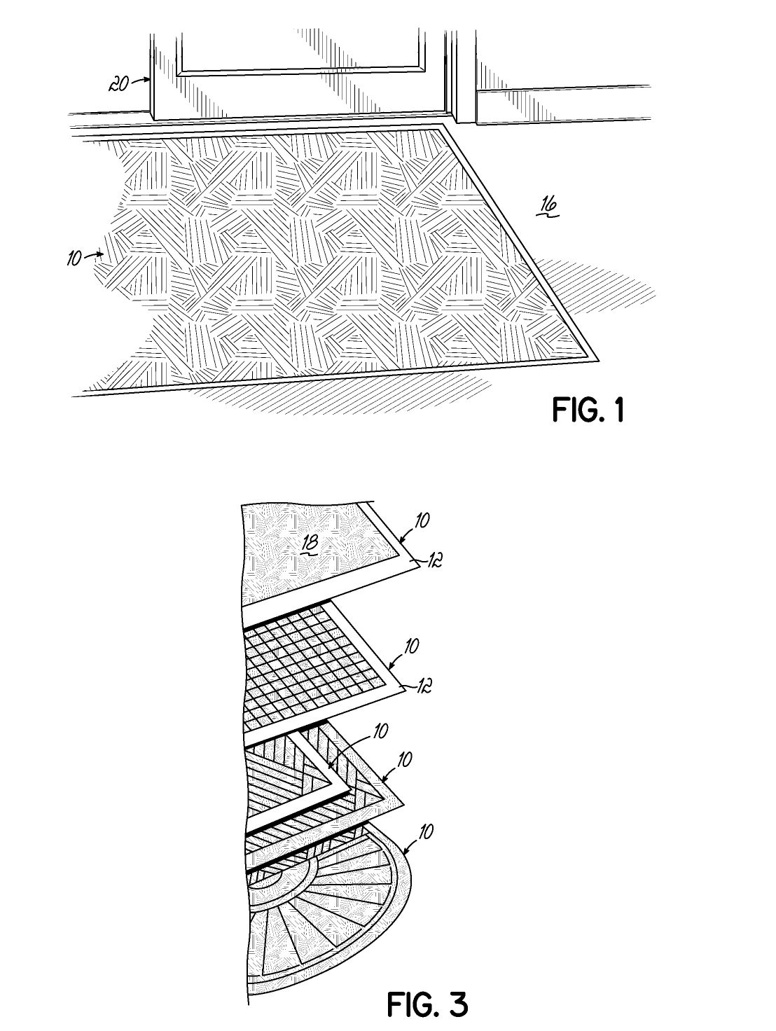

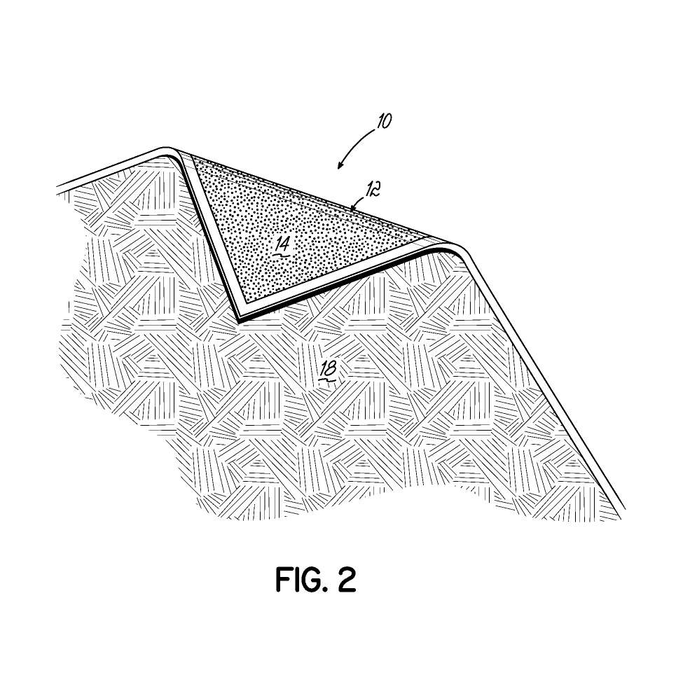

FIGS. 1-3 illustrate views of exemplary floor mat embodiments 10 of this invention. The mat 10 includes a base portion 12 which has a bottom surface 14, which rests on the existing floor structure 16. The base portion 12 may either be secured to the floor 16, for example with an adhesive means, or may be removably positioned on the floor 16, for example with double-sided tape, or other non-permanent means, or may simply be laid atop the existing floor 16. In the later case, the bottom surface 14 of the base portion 12 is preferably provided with a skid resistance surface, such as tread or ribs, known to those skilled in the art. The mat 10 has an upper pile portion 18.

The floor mat 10 of this invention is ideally suited for use in so-called wet or oily environments, wherein heavy traffic combines with the presence of water, oil, grease, spilled food, or other liquid or semi-liquid substances, thereby creating a possible hazard to pedestrians. One such environment is adjacent to an exterior door 20 as shown in FIG. 1.

The base 12 rests beneath a fiber-containing upper portion 18. The fiber-containing upper portion 18 may be an absorbent and/or adsorbent material adapted for absorbing watery and oily liquids and semi-liquids and has an upper surface adapted to reduce the incidence of pedestrian slippage or skidding on a floor 16 covered with the mat 10 in a wet or oily environment, relative to floor surfaces in similar environments which are not equipped with the mat 10.

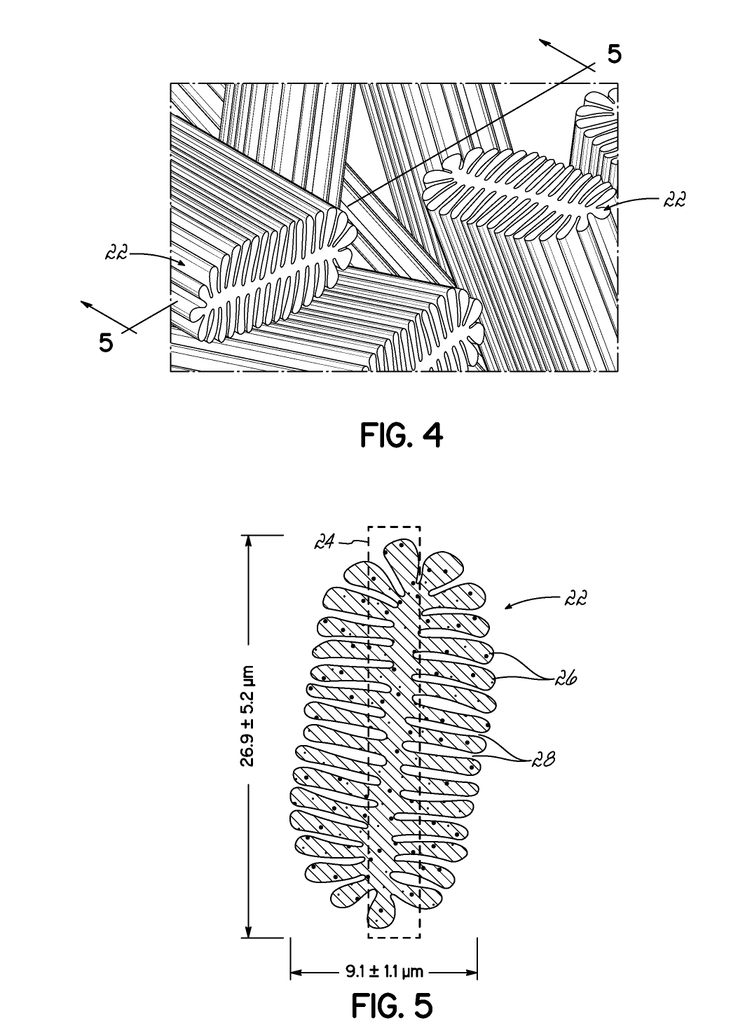

The upper pile portion 18 may be constructed of a winged fiber 22 as shown in FIGS. 4-6 capable of absorbing and/or adsorbing liquids and semi-liquids, such as through capillary attraction of oil molecules to the fibers. In some embodiments, the winged fiber 22 may be a winged microfiber, but this invention is not limited exclusively to winged microfiber pile portions 18 and such may be a winged fiber material.

The upper pile portion 18 may be bonded to the base 12 and in other embodiments adapted to enable the upper portion 18 to be removably attached to the base 12. This may be achieved by providing the pile 18 with a roughened texture, or fiber backing, which permits removable attachment such as with VELCRO®. The pile 18 may be provided with a separate backing layer, or more preferably comprises the same material used for the upper portion 18.

The upper portion 18 may be disposable in some embodiments of this invention, and may be constructed of a durable material that permits repeated use and washing in various embodiments. To clean the pile portion 18 with or without the base portion 12, it may be hosed off with a water rinse. Hot water and/or soap may be used as well as machine washing. After washing, the upper portion 18 and the base 12, if attached, is dried, either by drip-drying, wringing or machine drying. Heated dryers may be used. Alternatively, the upper portion 18 and base 12, if attached, may be dry-cleaned using conventional dry cleaning methods.

In many embodiments, the upper pile portion 18 is bonded to the base 12 and the entire mat 10 is thus cleaned, often in an industrial or commercial cleaning facility, one example of which is shown in U.S. Published Patent Application No. 2010/0051058, incorporated herein by reference. The base portion 12 may comprise a malleable rubberlike or plastic-like material. Such materials include, but are not necessarily limited to, polyvinyl chloride (“vinyl”), natural rubber, synthetic rubber, polyethylene, polyurethane, acrylonitrile, or other similar known materials. Alternatively, the base portion 12 may comprise a sponge-like material, such as foam rubber, or polyethylene foam, or other known equivalents thereof. Such materials provide a cushioned effect for the floor mat 10.

The upper portion 18 may be made of winged fibers or filaments 22. As seen in FIGS. 4-6, the winged fiber 22 generally includes a core middle region 24 having multiple lobes, projections or wings 26 extending outwardly from the core 24. A channel 28 is formed between each respective set of lobes 26. In one exemplary embodiment, the winged fiber 22 is a macro fiber, having a diameter in the realm of 10 microns. A typical cross-sectional dimension is for the winged fiber 22 to have a length of approximately 16-32 microns and a width of approximately 8-10 microns. This provides a fiber 22 of about 1.5 denier. In cross section, there may be a core of about 16 microns in length with a number of wings extending outwardly 3-5 microns on either side thereof. In this exemplary embodiment, each of the channels 28 has a width of 1 micron or less, preferably between 0.2 and 1 micron. Such winged fibers 22 have an increased surface area, at least 2 to 3 times the surface area of typically known fibers of the same denier size.

The winged fibers 22 can be formed by co-extruding the end fiber material, a polymer, with a sheath material which maintains the configuration of the channels 28 between the lobes 26. The extruded filament is then cut to length to form the fibers 22. If one tries to spin or extrude a single component fiber, such as 100 percent nylon, in the complex winged shape and with the overall dimensions as described, it will be immediately drawn together in a solid cylinder (i.e. back to a round fiber) before it can solidify. This problem is overcome by co-extruding the desired fiber inside another polymer. The center winged fiber 22 is then called an “island” and the second polymer sheath around the island is called the “sea.” After the fiber is fully formed, the sea polymer is washed away to leave the complex shape of the winged fiber 22.

The following polymers may be utilized to form the core, “island” portion of the winged fiber, but this listing is exemplary only and not exhaustive: polypropylene, polyester terephthalate, poly butyl terephthalate, polyamide, polyvinylidene fluoride, polylactic acid, polyamide 6, polyethylene and combinations thereof. Polymers that may be used as sea polymers include polylactic acid, polyvinyl alcohol, EastOne™, which is a polyester from Eastman Chemical, and esPET (an easily soluble polyethylene terephthalate).

In one embodiment, the winged fiber 22 has a middle region surrounded by between sixteen and thirty-two lobes 26. The surface area of the fiber 22 can be between 100,000 cm²/g and 1,000,000 cm²/g. The channels 28 of the fiber 22, defined between the lobes 26 have a width between about 200 nanometers and about 300 nanometers. Further, the lobes 26 can be uniformly spaced around the core 24.

Additional examples and details of winged fibers 22 appropriate for the mats of this invention are described in U.S. Pat. No. 8,129,019 and U.S. Published Patent Application Nos. 2008/0105612, 2013/0133980, 2013/0216829 and 2012/0148841. These documents are incorporated herein by reference in their entirety.

One embodiment of this invention is directed to the upper pile portion 18 of a mat 10 to be available in a broad range of weights, wherein the mats 10 exhibit significant capillarity through the use of the winged fibers or filaments 22. As a result of using these winged fibers 22, mat piles 18 containing these polymeric fibers in the macro range can be made far more absorbent than piles containing other types of macrofibers. Such piles 18 become rugged and reusable household and industrial mats with outstanding water or dust holding capabilities.

In one approach, a nonwoven web usable as the pile is achieved by melt spinning, stretching, and laying down the winged filaments with a titer of 1.0 to 10.0 DTEX. The filaments are immediately entangled by either needle-punching and/or hydro-entangling to form a three-dimensional network. The filaments contain a core 24 that forms the winged structure and a protective sheath that is subsequently washed to “release” the core winged structure. The protective sheath is normally 25 percent or less of the total initial fiber mass. The final fiber 22 will have a dimension not significantly different from the original fiber and may have diameters larger than 10 microns.

The staple discontinuous fibers of the nonwoven web can be mixed or blended or layered with other fibers, such as rayon, cotton, polyester and the like to form a hybrid structure containing both winged and non-winged fibers. The staple discontinuous fibers can also be mixed or blended or layered with other fibers or winged fiber or non-winged fiber of a different size to form a mixed denier structure. The staple discontinuous winged fibers can further be mixed or blended or layered with other multi-component fibers such as islands in the sea, segmented pie, and the like to form a structure containing splittable fibers or fibers that lend themselves to splitting and/or fibrillating by hydro-entangling. The fiber types, sizes and blend ratios may be determined on a case-by-case basis depending on the intended use. The fibers and/or filaments can also be formed into yarns that can be used to form the entire structure or loops extending from the structure by a knitting operation. The fibers and/or filaments can also be formed into yarns that are woven in a plain weave configuration, and the fabric is subsequently washed to release the core winged fiber. In both the knitted and woven embodiments, the discontinuous staple fibers can be co-mingled with other non-winged fiber types or formed in a core spun yarn containing the winged fibers in the core or the outside layer.

The specific mat 10 application may determine the most suitable type of polymer for forming the winged fiber 22. For example, for the absorption of oily liquids, a polypropylene mat 10 may be appropriate. Alternatively, water is better absorbed with a polyethylene terephthalate fiber or nylon fiber. The fiber can be charged, favoring polypropylene with additives. The selection of materials for the fiber can also take into account: strength, durability, feel/softness/hand, and whether the product is to be disposable.

A typical filamentary nonwoven pile 18 is formed by extruding a nylon core, poly-lactic acid sea continuous bicomponent filament forming a winged fiber 22. The nonwoven is then subjected to hydro-entangling at a pressure of 220 bar on both sides, with at least 5 injectors or manifolds. The fabric is then washed to remove the poly-lactic acid sheath and release the core winged fibers 22.

In a second example, a filamentary nonwoven pile is manufactured similarly to the prior example, except utilizing a polyester/poly-lactic acid continuous bicomponent filament.

The pile 18 of this invention provides the improved absorbency for a number of reasons. First, the nano-channels 28 formed between lobes 26 act to capture and hold the liquid by a capillary action. Second, the winged fibers 22 of this invention resist meshing or interlocking. Where a core 24 is provided with a limited number of lobes 26, and large channels, the lobes 26 of one fiber 22 are able to extend into the channels 28 of a second fiber 22. This interaction reduces the effective channel area used to absorb and hold liquid. Therefore since the lobes 26 of the winged fiber 22 according to this invention are spaced from and do not interact with the channels 28 of neighboring fibers 22, the pile 18 made from the winged fibers 22 maintains a high level of absorption.

The exceptional absorbency of the winged fiber 22 and of piles 18 made from the winged fiber 22 makes this material a prime candidate for applications which require absorbing and holding liquid. One advantage of the winged fiber's 22 exceptional wicking characteristics is to quickly transport liquids away until it can evaporate from the pile 18.

The same channels 28 that make the winged fiber 22 an improved absorbent material can also be turned around such that liquid held by the winged fiber 22 can be dispersed. The lobes 26 of the winged fibers 22 increase the flexibility of the fibers, improving the softness of the resulting products and making them suitable for use on sensitive areas such as bare feet.

The floor mat 10 of this invention significantly improves the floor surface in a wet environment. Liquids are absorbed or adsorbed or drained through the upper portion 18 and thus significantly reduce the likelihood of slipping which is present when such liquids merely lie on a nonabsorbent surface. Once the upper portion 18 has become saturated with liquid, it may be dried or cleaned for reuse as earlier indicated.

The mats 10 of this invention may be made to appropriate widths and lengths to provide for ease of application.

Many types of polymers and fibers have been used in mats 10, but nylon and polyester are desirable due to their resiliency (nylon) and heat resistance (polyester). This is a direct function of the environment for such mats 10 involving foot traffic and commercial dryers.

Winged fibers 22 enhance a textile's performance by increasing the capillarity within the channels 28. This fiber's core typically contains eight to 32 deep channels 28 between uniform, straight-edged lobes 26. The winged fiber 22 is lightweight and increases the surface area. The larger surface area enhances the ability to retain fluid such as water and oil. The winged fiber 22 size may be about the same as current nylon or polyester carpet fiber sizes. This means the winged fiber could have a similar appearance to carpet yarn, but offer 30 times more surface area.

As shown in FIGS. 1-3 the mat 10 according to the invention may include an upper layer consisting of a pile 18 with a nonwoven primary bottom for the pile, and the layer 18 has been fixed in the caoutchouc or plastic base 12 of the mat 10 by means of a hot pressing and/or vulcanizing process. The base 12 may consist of a sandwich construction comprising of two layers of rubber, viz. an upper inner caoutchouc layer and a lower caoutchouc layer, between which layers the reinforcing layer has been arranged and joint vulcanized with the two caoutchouc layers simultaneously with the press vulcanization onto the pile 18. The base 12 may extend beyond the pile 18 and may be provided with an approach ramp. Also the pile 18 may be provided with a similar ramp shape.

The invention also relates to a method of manufacturing a mat 10, whereby a pile layer, 18 and a base layer 12 may be joined in a hot press to form a unit. The layers 12, 18 arranged one upon the other are arranged in a hot press for a joint vulcanization of the caoutchouc layers until the edge shape shown in FIG. 3 is achieved. Instead of caoutchouc layers, plastic layers may be used, in which case no vulcanization process, but a softening process with heat, will be used, and whereby the backing layer 12 is then made of thermoplastic material which during the hot press operation will be heated to a temperature for a mutual adhesion between the four layers to take place.

The absorbent fiber layer structure is also a feature of this invention. It may combine an intimate admixture of thermoplastic fibers with other fibers such as wood pulp or natural or synthetic staple fibers having a basis weight in the range of from about 100 to 500 grams per square meter, about 150 to 250 grams per square meter. The composition may range from about 0 to 80 percent of the other fibers, and may be in the range of from about 60 to 80 percent wood pulp fibers by weight. The fibers may be thermoplastic polymers such as polyolefins, polyesters or polyamides having a diameter on the average in the range of up to about 15 microns and, in the range of up to about 10 microns.

The absorbent layer may be formed of winged fiber 22 which may or may not be winged microfiber in some embodiments. Materials for the melt blown fiber component may include polyolefins such as polypropylene and polyethylene, although other fibers may be used as will be apparent to those skilled in the art. If staple fibers are included, they may be polyester, polyolefins, polyamides or mixtures thereof, for example.

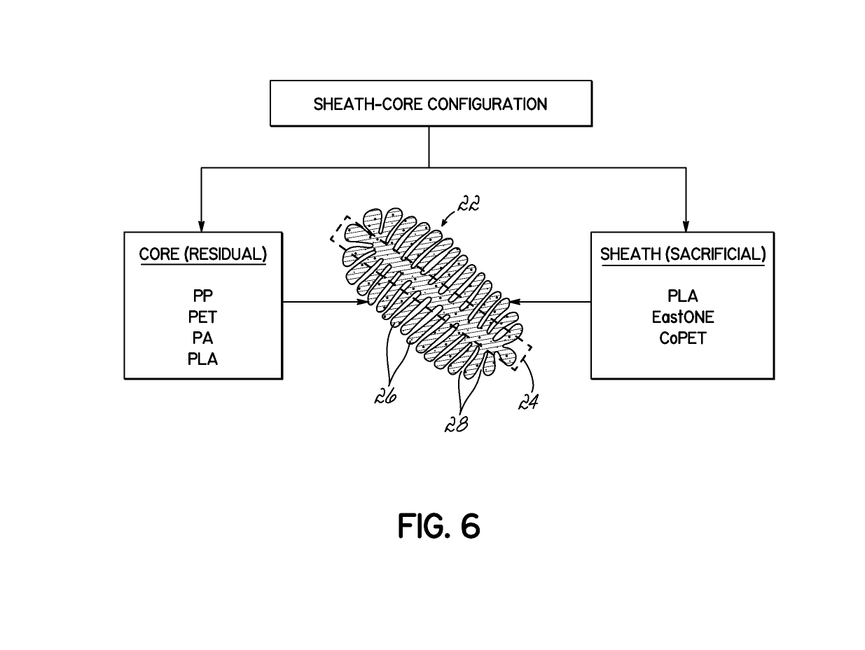

Referring to the drawing, FIG. 4 discloses a cross-section of the fiber 22 of this invention. As shown in FIGS. 5-6, the fiber 22 generally comprises an internal fiber core or middle region 24. The fiber 22 is generally constructed from two different polymer compositions that can be extruded in an oval cross-section, which allows for high processability. Alternatively, the cross-section can be circular or other shapes as desired.

As further shown in FIGS. 4-6, the cross-section of the internal fiber 22 has a generally winged-shape, or amoeba-like shape. The internal fiber 22 has a middle region 24, which is the longitudinal axis that runs down the center of the internal fiber 22. The longitudinal axis has a plurality of projections or lobes 26 that extend from the longitudinal axis, which are depicted in FIGS. 4-6. In one embodiment, the plurality of projections 26 extends along the periphery of the longitudinal axis. Alternative cross-sectional shapes, such as but not limited to a circular-shape or the like, would have the middle region 24 formed as a hub where the projections 26 extend from the hub. In one embodiment, the plurality of projections 26 is uniformly spaced. The plurality of projections 26 increases the surface areas and surface capillaries for a single fiber 22. In one embodiment, the plurality of projections 26 define a plurality of channels 28. In one embodiment, the plurality of channels 28 is uniformly spaced. The channels 28 create a surface capillary portion along the length of the fiber 22 that facilitates the absorption of liquids within the fiber 22. Additionally, the channels 28 allow particles, such as debris and dirt, to be picked-up and retained within the fiber 22. Thus, the fiber 22 of this invention has a plurality of longitudinal capillary channels 28 that extend along the length of the fiber 22 as shown in FIGS. 4-6. This invention also drastically increases the surface area of the cross-section of the internal fiber 22 due to the plurality of projections 26. The increased surface area created by the internal fiber 22 depends on the number of segments that are used during the manufacturing of the fiber 22.

The channels 28 may be nano-sized, having a width of about 200 nanometers. The channels 28 could be between 200 nanometers to 1000 nanometers. The width of the channels 28 can be modified to fit different applications. Because the channel size for each fiber 22 can be regulated, this invention can be used to create a textile fabric having fibers 22 with different channel sizes.

In one embodiment of this invention, the internal fiber 22 is a thermoplastic polymer known in the art. Any number of thermoplastic polymers can be used, such as but not limited to, polypropylene, polyester, nylon, polyethylene, thermoplastic urethanes (TPU), copolyesters, or liquid crystalline polymers.

In one embodiment the cross-section of the fiber 22 is highly flexible and has a solid interior. Alternatively, in one embodiment, the interior or middle region 24 of the internal fiber is a void. The void in the center forms an added channel 28 for fluid flow.

Alternatively, in another embodiment, the middle region 24 of the internal fiber 22 can be formed into a circular configuration during the extrusion process. This void allows the internal fiber 12 to be more rigid and have more bending resistance because of the void in the center. A fiber with a circular cross section with a void will have a lower tendency to bend over itself.

The fiber 22 may have an external sheath. In one embodiment the external sheath is a dissolvable thermoplastic, such as but not limited to, polyactide (PLA), co-polyester (PETG), polyvinyl alcohol (PVA), or ethylene-vinyl alcohol copolymer (EVOH). It is contemplated that any number of dissolvable thermoplastics known in the art may be used as the external sheath in connection with this invention. In one embodiment the external sheath encompasses the internal fiber 22.

One aspect of this invention is increasing the surface area of the fiber 22, while maintaining the denier of the fiber 22 between 1 and 3. In one embodiment, the denier of the fiber 22 is about 1.0 to about 2.0. However, alternatively, the denier of the fiber 22 can range from about 1.0 to about 20.0.

Denier is the unit used to measure the fineness of yarns, and is equal to the mass in grams of 9,000 meters of yarn. In one embodiment of this invention, the specific surface area for a one (1) denier fiber is about 28,000 and about 200,000 cm2/g.

Since the intended application as a floor mat 10 will subject the combination to wet or otherwise slippery conditions, some means may be provided to assure that the mat will maintain its position and not slip on the floor. This may be accomplished by means of a holder device or, more economically, by means of tacky adhesive applied to the exposed surface of the base 12. Such adhesives may be selected from those pressure-sensitive adhesives which are known to retain their tack for an extended period under wet conditions. Such include, for example, latex acrylic adhesives. Other embodiments include a high traction rubber base 12.

When a holder is desired, it may be one of those known for use in holding floor mats 10. As such, it will generally have beveled edges and be of a size such as to accommodate the mat without being so large as to permit the mat to be easily dislodged. If desired, retaining means may be incorporated in the holder to further ensure against undesired separation, or the mat 10 may include an adhesive as above described for attachment to the holder. Other attachment means may be employed as will be apparent to those skilled in the art. If an adhesive is used, it may be a permanently tacky pressure sensitive adhesive of the type described above and a release liner will preferably be used to protect the adhesive prior to the mat being placed in position. When it is desired to secure the mat 10, the release liner is removed, and the mat 10 pressed into a desired position. Such release liners are known and may include plastic sheets such as 1 mil thick polyethylene or a spunbonded nonwoven of 0.5 oz/ yard², for example, or paper treated with a release coat of silicone, polytretrafluoroethylene or other strippable material.

The mats 10 of this invention either alone or in combination with the holder, will find a wide variety of applications. For example, they may be used as either temporary or permanent fixtures at building entryways to protect against inclement weather or otherwise tracking in outside dust and dirt. Also they may be employed in industrial applications at entryways to cleanrooms, laboratories, or as undermats for automotive repair. Further, they may be used in hospitals to reduce opportunities for contamination. Other uses including household applications will be apparent to those skilled in the art.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. A floor mat for placement upon a floor, the mat comprising:
a base;
a fiber-containing pile portion attached to the base;
wherein the fiber-containing pile portion includes an absorbent material adapted for absorbing liquids and for permitting drainage of liquid therethrough;
wherein the fiber-containing pile portion includes a plurality of winged fibers.

2. The floor mat of claim 1 wherein the fiber-containing pile portion is washable.

3. The floor mat of claim 1 wherein the fiber-containing pile portion includes winged fibers selected from the group of polyester, polypropylene and combinations thereof.

4. The floor mat of claim 1 wherein the fiber-containing pile portion further comprises winged microfibers.

5. The floor mat of claim 1 wherein the base is comprised of material selected from the group of polyvinyl chloride, natural rubber, synthetic rubber, polyethylene, polyurethane and acrylonitrile.

6. The floor mat of claim 5 wherein the base further comprises a perforated structure that permits liquids to pass therethrough.

7. The floor mat of claim 5 wherein the base further comprises a closed structure that prevents liquids from passing therethrough.

8. The floor mat of claim 1 wherein the winged fibers further comprise:
a plurality of polymeric filaments with a filament titer of 1.0 to 10 dtex.

9. The floor mat of claim 1 wherein the winged fibers further comprise:
a plurality of channels each formed between an adjacent pair of projections and measuring up to one micron in width.

10. The floor mat of claim 9 wherein the projections of the winged fibers are spaced from the channels of adjacent winged fibers.

11. The floor mat of claim 9 wherein the winged fibers each comprises a middle region having between 16 projections and 32 projections extending from the middle region and around a periphery of the middle region.

12. The floor mat of claim 1 wherein the pile portion is a non-woven material.

13. The floor mat of claim 1 wherein the pile portion is a woven material.

14. The floor mat of claim 1 wherein the pile portion further comprises non-winged fibers.

15. The floor mat of claim 1 wherein each of the plurality of winged fibers has a length of between about 16 to 32 microns and a width of between about 8 to 10 microns and each of a plurality of projections extending outwardly from a middle region of the winged fiber has a length of about 3 to 5 microns.

16. The floor mat of claim 1 wherein the winged fibers are one of polypropylene, polyethylene terephthalate and nylon.

17. A floor mat for placement upon a floor, the mat comprising:
a base;
a fiber-containing pile portion attached to the base;
wherein the fiber-containing pile portion includes an absorbent material adapted for absorbing liquids and for permitting drainage of liquid therethrough;
wherein the fiber-containing pile portion includes a plurality of winged fibers having a plurality of channels each formed between an adjacent pair of projections;
wherein the projections of the winged fibers are spaced from the channels of adjacent winged fibers.

18. The floor mat of claim 17 wherein the pile portion further comprises non-winged fibers.

19. The floor mat of claim 17 wherein the fiber-containing pile portion further comprises winged microfibers.

20. The floor mat of claim 17 wherein the winged fibers each comprises a middle region having between 16 projections and 32 projections extending from the middle region and around a periphery of the middle region.
